(19) United States
(12) Patent Application Publication
(10) Pub. No.: US 2024/0083532 A1
(43) Pub. Date: Mar. 14, 2024

(54) TRAILER FOR TRANSPORTING COMBINE HEADERS

(71) Applicant: CL Fabrication, Inc., Clarinda, IA (US)

(72) Inventors: CURTIS HULL, Clarinda, IA (US); JACOB D. HULL, Clarinda, IA (US)

(21) Appl. No.: 18/465,527

(22) Filed: Sep. 12, 2023

Related U.S. Application Data
(60) Provisional application No. 63/375,416, filed on Sep. 13, 2022.

(51) Int. Cl. B62D 63/08; B60B 35/00; B62D 21/14; B62D 27/06

(52) U.S. Cl. CPC B62D 63/08; B60B 35/006; B62D 21/14; B62D 27/065; B60P 3/00

(57) ABSTRACT

Trailers or other towed apparatuses are used to transport agricultural equipment. This can include combine heads, such as the heads for corn or soybean. The combine heads are extended on the trailer in an elongated manner that is in the longitudinal length or direction of the travel of the trailer. Due to the length of the trailer, it is advantageous to construct the trailer out of multiple segments that are bolted together to for an elongated unit. The trailer includes one or more rear axles that can be position-adjustable to adjust the wheelbase for the trailer and to account for equipment of various sizes. A rear hitch at the distal end of the trailer allows for the trailer to connect to and/or haul additional equipment.

### CROSS REFERENCE TO RELATED APPLICATIONS

This application claims priority under 35 U.S.C. § 119 to provisional patent application U.S. Ser. No. 63/375,416, filed Sep. 13, 2022. The provisional patent application is herein incorporated by reference in its entirety, including without limitation, the specification, claims, and abstract, as well as any figures, tables, appendices, or drawings thereof.

### TECHNICAL FIELD

The present disclosure relates generally to a trailer or other towed apparatus for use in transporting equipment, such as agricultural equipment. More particularly, but not exclusively, the disclosure includes improvements to trailers and other towed apparatuses for transporting agricultural equipment, such as combine headers, that include a significant longitudinal length in the direction of travel during transport.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

The size of harvesting equipment in the agricultural industry has increased for several decades. This includes increasing the width of harvesting heads to be able to reap (i.e., harvest) more of a field at a time, which can reduce the total amount of time needed to complete the task. The increased width of these heads, such as a corn or bean head on a combine, makes it impractical and unsafe for the combine to drive down a road with the head mounted on the combine. Elongated trailers are often used to haul these heads down the road so that the head width is oriented in the direction of travel. When the corn or bean head is to be removed from the combine and loaded onto the trailer, the combine approaches the trailer from one side and raises the head above the trailer.

Due to the elongated length required in the longitudinal direction of travel for a trailer holding and transporting the combine heads, the construction and functionality can be limited. Traditionally, elongated steel tubing is used to form a frame that will be able to hold the combine heads during transport. Constructing equipment with such elongated components is difficult and expensive. Additionally, there is little flexibility in creating trailers or other towed equipment that can be varied in elongated or longitudinal length, as the length of the equipment is limited by the length of the elongated steel tubes.

Thus, there exists a need in the art for a combine head transporting apparatus that is easier and more cost efficient to construct, while also providing flexibility to adjust or vary the elongated length thereof in an easier manner.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of the present disclosure to improve upon towed equipment that is used to transport equipment that extends a significant length in a direction of travel. For example, combine heads for both corn and soybeans can be transported with an improved trailer or other towed vehicle.

It is still yet a further object, feature, and/or advantage of the present disclosure to construct a towed vehicle that includes a number of segments that are bolted together to increase the elongated length thereof. The length of the towed vehicle is adjustable based upon the number of segments bolted together.

It is yet another object, feature, and/or advantage for a towed agricultural vehicle used to transport agricultural equipment to include a tilted frame comprising a number of segments bolted together.

It is still a further object, feature, and/or advantage for a towed agricultural vehicle used to transport agricultural equipment to include an adjustable rear axle and/or a rear receiver at the distal end of the elongated frame.

The towed agricultural vehicle disclosed herein can be used in a wide variety of applications. For example, while it may be made for transporting combine headers, the towed vehicle could transport any elongated component, agricultural or otherwise.

It is preferred the apparatus be safe, cost effective, and durable.

At least one embodiment disclosed herein comprises a distinct aesthetic appearance. Ornamental aspects included in such an embodiment can help capture a consumer's attention and/or identify a source of origin of a product being sold. Said ornamental aspects will not impede functionality of towed apparatus.

Methods can be practiced which facilitate use, manufacture, assembly, maintenance, and repair of a towed agricultural equipment which accomplish some or all of the previously stated objectives.

According to at least some aspects and/or embodiments of the present disclosure, an agricultural trailer comprises an elongated frame, said frame comprising a plurality of segments, each segment comprising a lower side and a higher side connected via a crossbar; wherein each of the plurality of segments connected to one another at flanges via mechanical fasteners; and at least one rear axle operatively connected to one of the plurality of segments in a variable location relative to the segment such that the at least one rear axle is movable in a longitudinal direction of the segment.

According to at least some aspects of some embodiments, the trailer further comprises a rear axle mounting bracket on the at least one segment, said rear axle mounting bracket comprising a plurality of mounting locations for the rear axle.

According to at least some aspects of some embodiments, the rear axle mounting bracket comprises spaced apertures for aligning with an attachment of the rear axle.

According to at least some aspects of some embodiments, the rear axle comprises a mount with portions that align with the spaced apertures of the rear axle mounting bracket on the at least one segment.

According to at least some aspects of some embodiments, the mechanical fastener comprises a bolt.

According to at least some aspects of some embodiments, the flanges connecting the plurality of segments are angled to at least partially arch the segments relative to one another.

According to at least some aspects of some embodiments, the flanges are angled to arch the segments approximately 0.5-degrees.

According to at least some aspects of some embodiments, the trailer further comprises a secondary hitch receiver at a rear portion of a rear-end segment.

According to at least some aspects of some embodiments, the elongated frame comprises three segments, and at least one of the three segments comprising a different elongated length.

According to additional aspects and/or embodiments of the present disclosure, an agricultural trailer comprises an elongated frame, said frame comprising a plurality of segments, each segment comprising a lower side and a higher side connected via a crossbar; wherein each of the plurality of segments connected to one another at flanges via mechanical fasteners; and wherein the flanges connecting the plurality of segments are angled to at least partially arch the segments relative to one another.

According to at least some aspects of some embodiments, the flanges are angled to arch the segments approximately 0.5-degrees.

According to at least some aspects of some embodiments, the elongated frame comprises three segments, and at least one of the three segments comprising a different elongated length.

According to at least some aspects of some embodiments, both connections between the three segments are angled to include the arch.

According to at least some aspects of some embodiments, the trailer further comprises at least one rear axle operatively connected to a most rearward segment via a variable location relative to the segment such that the at least one rear axle is movable in a longitudinal direction of the segment, and further comprising a rear axle mounting bracket on the at least one segment, said rear axle mounting bracket comprising a plurality of mounting locations for the rear axle.

According to at least some aspects of some embodiments, the rear axle mounting bracket comprises spaced apertures for aligning with an attachment of the rear axle.

According to at least some aspects of some embodiments, the rear axle comprises a mount with portions that align with the spaced apertures of the rear axle mounting bracket on the at least one segment.

According to at least some aspects of some embodiments, the trailer further comprises one or more saddles operatively connected to one or more segments of the frame, said one or more saddles configured to receive a portion of a component stored on the frame.

According to additional aspects and/or embodiments of the present disclosure, a variable length agricultural trailer comprises an elongated frame, said frame comprising a plurality of segments, each segment comprising a lower side and a higher side connected via a crossbar; wherein each of the plurality of segments connected to one another at flanges via mechanical fasteners; wherein at least one of the plurality of segments comprising a different length; a rear axle mounting system to adjust the length of wheelbase between a front axle and at least one rear axle, comprising a rear axle mount to mount the at least one rear axle at one or multiple locations on the frame.

According to at least some aspects of some embodiments, the rear axle mounting system comprising present locations for mounting rear axle.

According to at least some aspects of some embodiments, the flanges connecting the plurality of segments are angled to at least partially arch the segments relative to one another.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 is a view of a towed agricultural apparatus, such as for use in transporting elongated equipment (e.g., combine heads) that extend a significant length in a longitudinal manner in the direction of travel.

FIG. 2 is a close up view showing adjustable double rear axles for the towed apparatus with varying locations for the axles, which can be used to adjust the wheelbase of the apparatus for transport.

FIG. 3 is a close up view showing a portion of a towed agricultural apparatus, including an adjustable axle for adjusting the wheelbase of the towed apparatus.

FIG. 4 is a close up view showing the opposite end of the adjustable axle shown in FIG. 3.

FIG. 5 is a rear perspective view of the towed apparatus, including a rear hitch at a distal location of the apparatus.

FIG. 6 is another view showing a rear perspective of the towed apparatus showing additional aspects of the apparatus.

FIG. 7 is a side elevation view of a towed apparatus showing additional features of some aspects of some embodiments of the present disclosure.

FIG. 8 is another side elevation view a towed apparatus showing additional features of some aspects of some embodiments of the present disclosure.

An artisan of ordinary skill in the art need not view, within isolated figure(s), the near infinite distinct combinations of features described in the following detailed description to facilitate an understanding of the present disclosure.

### DETAILED DESCRIPTION

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “invention” is not intended to refer to any single embodiment of the particular invention but encompass all possible embodiments as described in the specification and the claims. The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

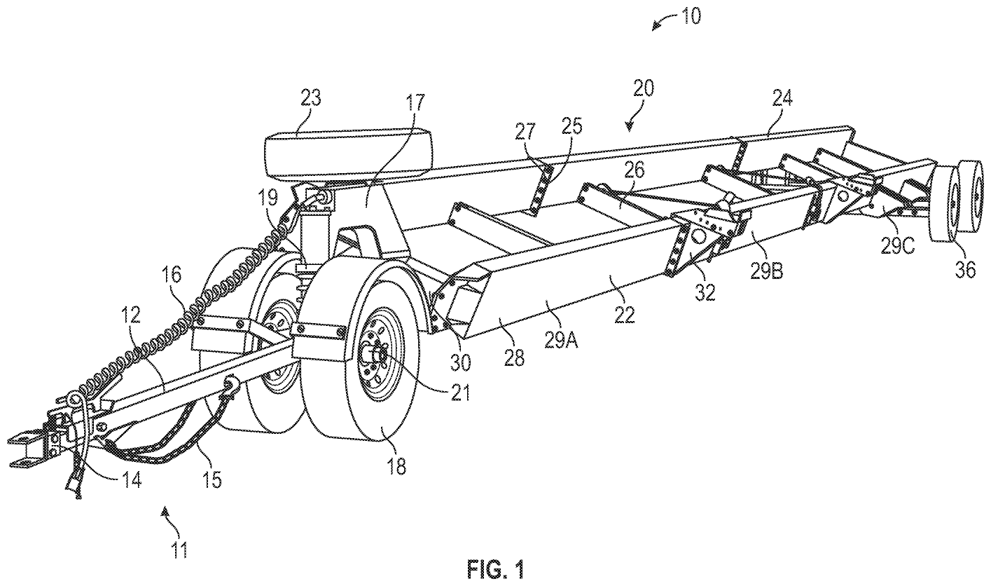

As shown in the figures, and in particular FIG. 1, an agricultural trailer 10 is shown. The agricultural trailer 10 may be a trailer or other towed equipment that is used to transport agricultural equipment or other components. For example, combine headers for corn or soybean can be transported on such a trailer. The combine headers are generally wide components, which require them to be positioned on a trailer in a manner in which the significant length of the headers extends generally in the longitudinal direction of the trailer 10, which is also the longitudinal direction of travel for the trailer/head combination as it is transported down a road or other pathway.

Therefore, the length of the trailer 10 must also extend the significant length of the head. However, as different heads may comprise different lengths, there may be a need to construct trailers of varying lengths. This can be accomplished by allowing the trailer frames to be constructed in a manner that is easily adjusted and/or by providing axles with adjustable positioning to adjust the wheelbase between front and rear wheels of the trailer 10. As will be understood, aspects and/or embodiments provided herein provide for numerous advantages for the construction and/or operation of such trailers.

Accordingly, as shown in FIG. 1, the trailer 10 includes a tongue 12 with a hitch 14 at a first end 11. The tongue 12 also includes safety chains 15 and a coiled electrical cord 16, which is connected to a tow or prime vehicle for towing the trailer 10. The electrical cord 16 is a connection to provide electrical power to the trailer, such as for lights, brakes, actuators, alerts, and any other electrical component of the trailer 10.

Also located at or near the tongue 12 are a set of front transport wheels 18. The figures shows two front transport wheels 18 at the distal end of the tongue 12 and supporting a front portion of a frame 20 of the trailer 10, but this need not be the case in all versions. The wheels 18 are at opposite sides of a front axle 21. The front wheels 18 can be connected to the frame 20 with a tricycle style suspension 19 to allow for some vertical motion of the front end 11 of the trailer 10, which will provide a smoother ride for the trailer and any component thereon. The suspension 19 transitions the tongue 12 to the frame 20 via a gooseneck 17. A spare tire 23 is mounted at the gooseneck 17 as well, but this is not required in all embodiments of the disclosure.

Extending rearwardly from the tongue 12 and front wheels 18 is a frame 20 for holding an agricultural component, such as a combine head. The frame 20 extends a significant distance in an elongated manner, which is a length that will an elongated component, such as a combine head. This may be described as being in a longitudinal direction that is in the direction of travel for the trailer 10 during transport. While the length of the trailer frame is not to be limiting on the disclosure, it should be appreciated that the length should be able to hold and transport combine headers of various widths. Therefore, it may be considered that the significant length of the trailer be greater than 27-feet. Still further, it should be appreciated that the length be greater than 20-feet and up to or even more than 50-feet, depending on the width of the combine header or other component being transported by the trailer.

The trailer frame 20 is shown to be tilted, with one side being higher relative to the ground than the other. The tilting of the trailer 10 provides some advantages to the transport of combine headers and other long equipment or components. For example, having a tilted frame with one side higher than the other relative to the ground allows for different combine headers to better fit on the frame in a more secured manner.

As is shown in the figures, and in particular in FIGS. 1, 5, and 6, the frame 20 comprises a number of steel components that are bolted together. For example, there is the lower frame side 22 and the opposite, upper frame side 24 that are connected by a number of cross supports 26. Still further, each of the lower 22 and upper 24 sides include a number of elongated members 28 that are bolted together to form the length of the trailer 10.

The connection of the side members 22, 24 and the cross support members 26 by bolting or other mechanical fasteners is different from and provides advantages over the traditional manner of construction for trailers of this type. Traditional trailers comprise elongated side members that are one piece in construction (i.e., casted) for the length of the trailers. This is very limiting on the length of the trailers, and requires pieces of significant length, which can increase the cost and/or complexity of constructing the trailer frames.

Using multiple frame segments 29 of shorter length that is bolted together makes construction of the trailer frames easier. The segments 29 may be referred to as the sides and cross supports that are connected to one another. As shown in FIG. 1, the trailer 10 includes three such segments, a first or front segment 29A, second or middle segment 29B, and a third or rear segment 29C. The bolts used to connect the components of the segments and the segments themselves reduce need for welds and precise lengths of long members for the length of the trailer frame 20.

Still further, the bolts may allow for greater flexibility for the variability in the length of the trailer 10. For example, as shown in FIG. 1, the frame 20 includes three elongated segments 29A, 29B, 29C that are bolted together with cross-supports 26 to form the frame 20. According to at least some aspects and/or embodiments, the first (front) 29A and third (most distal) 29C segments could be standard lengths, regardless of the overall length of the trailer required. The middle segment 29B could come in multiple and variable lengths to account for whatever length of the trailer that may be needed, such as to account for the varying lengths of the combine heads or other equipment. Bolting the segments together provides for a quicker and easier way to swap out the segment(s) to provide varying, elongated lengths.

Likewise, the bolting of the cross supports 26 to the elongated members 28 provides at least some flexibility and/or variability for the trailer frame 20. The cross supports 26 can be standard sizes, such as if the equipment being transported is a standard size. However, if different equipment is to be transported, or if people request trailers with different widths, the length of the cross support bars can be varied and said supports can be quickly connected via the bolts to the side portions 28 to bolster the structural integrity thereof.

According to some embodiments, the elongated side components 28 and the cross supports 26 comprise steel tubing of various geometries. For example, the components may be various sizes of rectangular-shaped steel tubing. Additionally, the side pieces are shown to have flanges 25 at the connection points (i.e., the connection of the components via the bolts or other mechanical fasteners). The flanges 25 include the connections for the bolts to connect the components to one another.

Still further, the front and rear cross bars or supports may be connected via cross member brackets 30 at the front and rear of the frame 20. The brackets 30 provide additional support and structural integrity for the connection of the cross members 26 at the front and rear of the frame 20.

Also shown in the figures is a number of saddles 32 or the like that are connected to the lower side pieces 22 of the frame 20. The saddles 32 are configured to receive components of the combine heads to provide better support during transport. Therefore, the saddles 32 can be C-shaped or other shaped to receive and generally hold a portion of the carried equipment and to aid in mitigating movement of the equipment on the trailer 10.

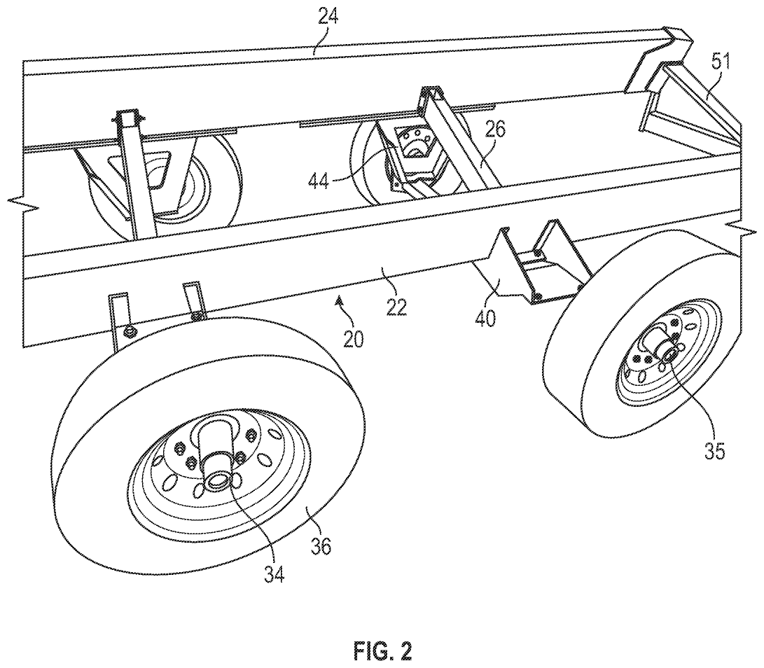

Referring now to FIGS. 2-4, rear axles 34, 35 are shown. The figures show two rear axles, but it should be appreciated that the exact number should not be limiting to the disclosure. It should be appreciated that single rear axles or multiple rear axles can be included, such as depending on the overall length of the frame 20 of the trailer 10, as well as the weight of the components being supported and transported thereon.

The rear axles 34, 35 include wheels 36 on opposite sides of the frame 20. Furthermore, the rear axles 34, 35 are adjustable in longitudinal position along the length of the side rails, which can adjust the wheelbase between the front and rear wheels, as well as to adjust the wheelbase between the two sets of rear axles. The latter can be useful for spreading out the weight of a transporting component over the length of the trailer, while the former provides greater control and turning for the elongated trailer.

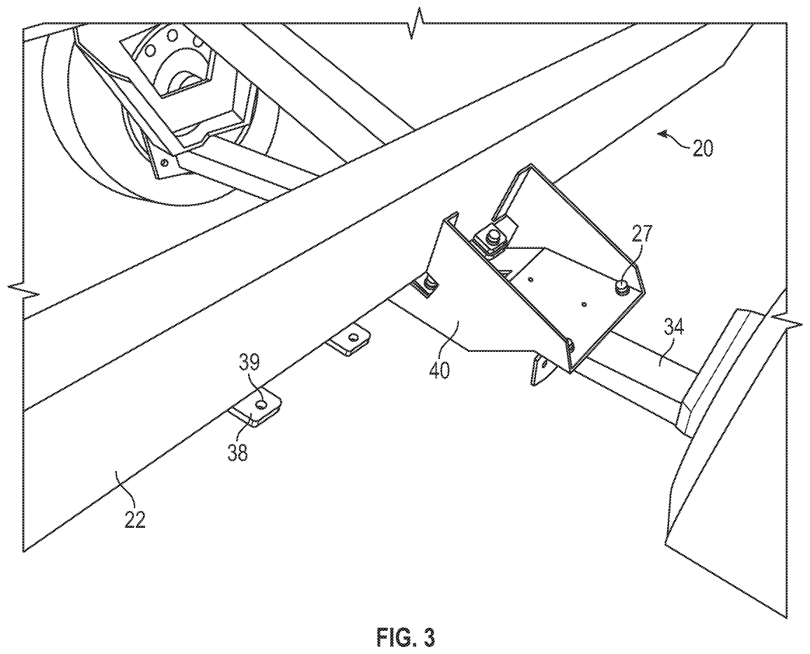

Each of the rear axles 34, 35 will be substantially similar to one another in construction, which will allow for the adjustability for both of the axle/wheel combinations. The lower side rail 22 of the trailer frame 20 at one of the rear axles is shown in FIG. 3. As shown, a number of tabs 38 extend from the lower side rail 22, with each tab 38 including an aperture 39. The tabs 38 are shown to extend generally laterally from the side rail with vertical axis apertures. The axle assembly includes a lower side mounting bracket 40 connected to the rear axle. The lower side mounting bracket 40 includes mechanical fasteners (e.g., bolts) for connecting to the axle, which may be via an L-shaped mount. Near the lower side rail 22, the lower side mounting bracket 40 includes spaced apertures which are spaced similar to the spacings between the tabs 38 of the lower side rail. Therefore, alignment of the lower side mounting bracket 40 with two corresponding tabs 38 of the lower side rail will provide a set location for connection between the axle and the lower side rail. According to at least some embodiments of the present disclosure, there are five spaced tabs 38 on the lower side rail 22, which provides for four different locations for the mounting of the axle, which provides adjustability of the wheelbase of the trailer. However, the number of tabs and thus, the number of preset mounting locations can be greater or less depending on the amount of adjustability desired for a particular trailer. Still further, it should be appreciated that the tabs are replaced by an elongated member to allow for near infinite positioning locations for the axles. This would allow the axle to be essentially slid along the elongated mounting member and then held in place by clips, bolts, clamps, or other mechanical connections to hold the axle in place desired.

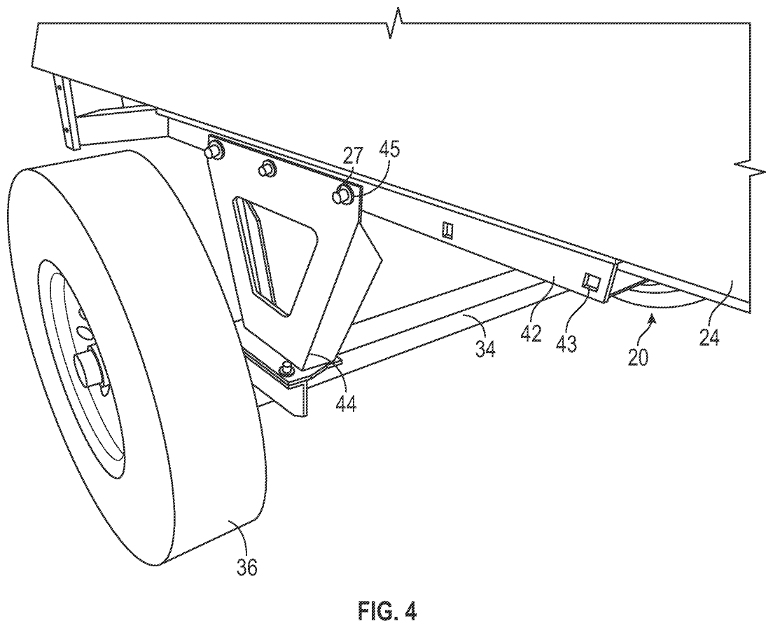

Moving now to FIG. 4, the higher side rail 24 of the frame 20 is shown at one of the rear axles. Extending from the higher side rail 24, for example, in a vertical manner, is a bracket 42 with spaced apertures 43. Extending upward from the axle is a higher side mounting bracket 44 that is used to connect the axle to the higher side rail 24. The lower portion 44 of the high side mounting bracket 42 includes a bolted connection to the axle, such as via a lower, fixed location bracket 46. The upper portion of the higher side mounting bracket 44 includes a number of apertures 45 that are spaced according to the spacing of the bracket 42 on the higher side rail 24. The figure shows the higher side mounting bracket 44 with three apertures 45A, 45B, 45C, but this is not to be limiting. The apertures of both brackets 42, 44 can be aligned and fastened with a mechanical fastener, e.g., a bolt. The location of the mounting bracket 44 to the fixed bracket 42 on the side rail, along with the positioning of the bracket 40 on the lower side rail 22, provides for adjustable mounting of the axle along the longitudinal length of the frame, which again, provides for adjustability in the wheelbase between the front and rear tires, as well as between the two rear axles. Similar to the lower side, the brackets provide for four different locations of mounting the rear axle on the high side rail, but this exact number should not be limiting on the disclosure.

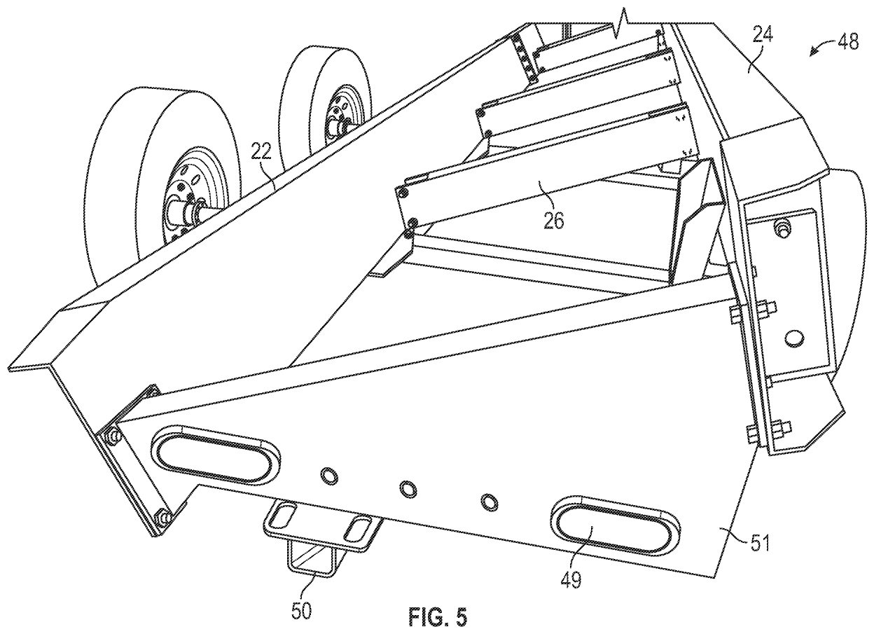

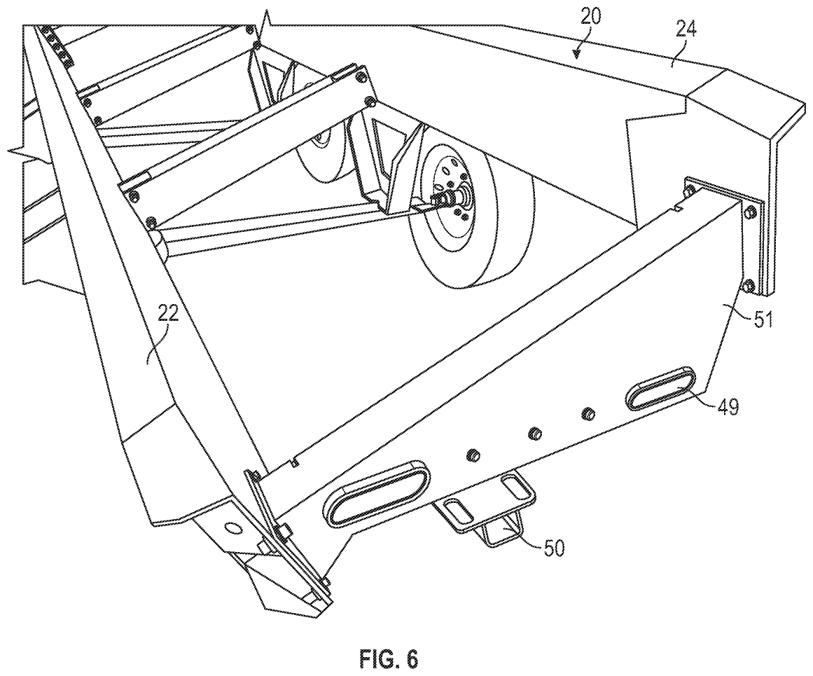

FIGS. 5 and 6 show still additional aspects of some embodiments of the transport trailer 10. The figures show the distal or rear end 48 of the trailer 10, which is opposite the tongue 12. Lights 49 are shown at the rear of the trailer, which can be controlled via the cable connected to the prime mover or other tow vehicle. A rear cross support 51 connects the distal ends of the lower and higher side rails and includes the mounts for the lights.

Still further shown in the figures, a rear hitch receiver 50 is shown included on the rear cross support 51. The rear hitch receiver 50 is positioned generally at a lower portion of the rear support member and can be welded or otherwise connected thereto. The rear hitch receiver 50 can be used to attach additional trailers or other towed apparatus to the trailer 10 to allow the tow vehicle to tow even more components. The hitch receiver 50 at the rear of the trailer 10 can receive any number of hitches, such as ball hitches or the like. Still further, it should be appreciated that the rear receiver could also include an electrical connection (not shown) for providing electrical power to the towed vehicle behind the trailer.

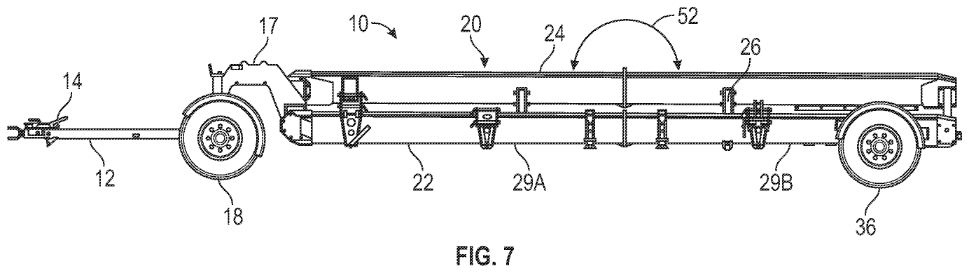

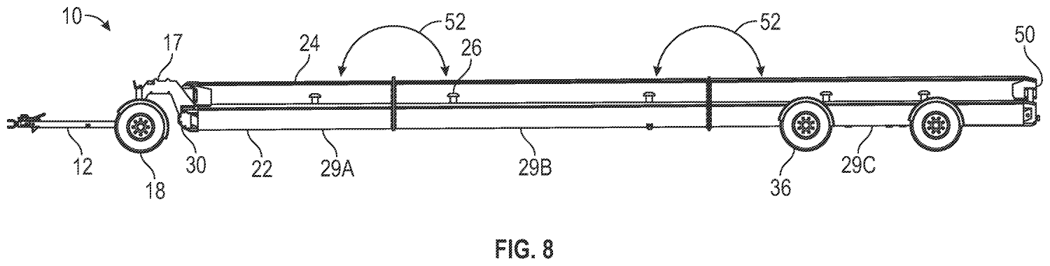

FIGS. 7 and 8 show additional aspects of at least some embodiments of the present disclosure. As noted, the segments 29 of the trailer frame 20 can be bolted or otherwise mechanically connected to allow for variations to the length of the trailer 10. The flanges 25 that connect the segments can be angled to create an upward arch at the connection of the segments in the main frame rails by tilting the connector plates (i.e., flanges) slightly. According to some embodiments, the arch is about one-half of a degree. This is shown by the arrow 52 of the arch in the figures. The arch will aid in counteract the flex under heavy loads of the components that are stored and transported by the trailer 10.

FIG. 7 shows a trailer 10 with two segments 29 along the longitudinal length of the trailer 10. In this embodiment, there may be a single arch. FIG. 8 shows a longer trailer 10 comprising three segments 29 connected to one another. In such an embodiment, the connection plates/flanges 25 can each include the arch to counteract the flex caused by the heavier loads. This is shown by both arrows/arches 52 in the figure. It should be noted that the angle of the arches in FIG. 7 can be equal to one another or can be varied. For example, some components may have heavier portions along the length of the component, and therefore, one connection may include an arch or a greater arch than the other, or both can be the same. In addition, if more segments 29 are connected to one another to create even longer trailers, or if shorter segments are used, each of the connection points of the segments can include such an arch.

As noted, mechanical fasteners, such as bolts, can be used to connect various components or portions of the trailer. In general, a mechanical fastener is a device that is used to mechanically join or fasten two or more objects together. In general, fasteners are used to create non-permanent joints or connections; that is, joints that can be removed or dismantled without damaging the joining components. General types of mechanical fasteners can include threaded (bolts, screws, nuts, studs, etc.) or non-threaded (keys, pins, retaining rings, etc.). Additional fasteners can include, but are not limited to nails, rivets, and the like. Non-mechanical fasteners may include adhesives, fittings, clearance fittings, friction fittings, compression fittings, transition fittings, snaps, snap fits, hook and loops, joints, and the like. For simplistic purposes, screws, nuts, bolts, pins, rivets, staples, washers, grommets, latches (including pawls), ratchets, clamps, clasps, flanges, ties, adhesives, welds, any other known fastening mechanisms, or any combination thereof may be used to facilitate fastening, may be used for any of the connections described herein and all are to be considered swappable with one another for any of the attachment, connection, and/or fastening of components, either temporarily or permanently. It is further considered that any combination of any of the listed mechanical and/or non-mechanical fasteners or methods of fastening are to be considered a part of the disclosure.

Therefore, a transport trailer for transporting elongated agricultural equipment or other components has been shown and/or described. It should be appreciated that any number of changes, adjustments, variations, or the like, which would be obvious to those skilled in the art, should be considered to be a part of the present disclosure.

1. An agricultural trailer, comprising:
an elongated frame, said frame comprising a plurality of segments, each segment comprising a lower side and a higher side connected via a crossbar;
wherein each of the plurality of segments connected to one another at flanges via mechanical fasteners; and
at least one rear axle operatively connected to one of the plurality of segments in a variable location relative to the segment such that the at least one rear axle is movable in a longitudinal direction of the segment.

2. The agricultural trailer of claim 1, further comprising a rear axle mounting bracket on the at least one segment, said rear axle mounting bracket comprising a plurality of mounting locations for the rear axle.

3. The agricultural trailer of claim 2, wherein the rear axle mounting bracket comprises spaced apertures for aligning with an attachment of the rear axle.

4. The agricultural trailer of claim 3, wherein the rear axle comprises a mount with portions that align with the spaced apertures of the rear axle mounting bracket on the at least one segment.

5. The agricultural trailer of claim 1, wherein the mechanical fastener comprises a bolt.

6. The agricultural trailer of claim 1, wherein the flanges connecting the plurality of segments are angled to at least partially arch the segments relative to one another.

7. The agricultural trailer of claim 6, wherein the flanges are angled to arch the segments approximately 0.5-degrees.

8. The agricultural trailer of claim 1, further comprising a secondary hitch receiver at a rear portion of a rear-end segment.

9. The agricultural trailer of claim 1, wherein the elongated frame comprises three segments, and at least one of the three segments comprising a different elongated length.

10. An agricultural trailer, comprising:
an elongated frame, said frame comprising a plurality of segments, each segment comprising a lower side and a higher side connected via a crossbar;
wherein each of the plurality of segments connected to one another at flanges via mechanical fasteners; and
wherein the flanges connecting the plurality of segments are angled to at least partially arch the segments relative to one another.

11. The agricultural trailer of claim 10, wherein the flanges are angled to arch the segments approximately 0.5-degrees.

12. The agricultural trailer of claim 10, wherein the elongated frame comprises three segments, and at least one of the three segments comprising a different elongated length.

13. The agricultural trailer of claim 12, wherein both connections between the three segments are angled to include the arch.

14. The agricultural trailer of claim 10, further comprising at least one rear axle operatively connected to a most rearward segment via a variable location relative to the segment such that the at least one rear axle is movable in a longitudinal direction of the segment, and further comprising a rear axle mounting bracket on the at least one segment, said rear axle mounting bracket comprising a plurality of mounting locations for the rear axle.

15. The agricultural trailer of claim 14, wherein the rear axle mounting bracket comprises spaced apertures for aligning with an attachment of the rear axle.

16. The agricultural trailer of claim 15, wherein the rear axle comprises a mount with portions that align with the spaced apertures of the rear axle mounting bracket on the at least one segment.

17. The agricultural trailer of claim 10, further comprising one or more saddles operatively connected to one or more segments of the frame, said one or more saddles configured to receive a portion of a component stored on the frame.

18. A variable length agricultural trailer, comprising:
an elongated frame, said frame comprising a plurality of segments, each segment comprising a lower side and a higher side connected via a crossbar;
wherein each of the plurality of segments connected to one another at flanges via mechanical fasteners;
wherein at least one of the plurality of segments comprising a different length;
a rear axle mounting system to adjust the length of wheelbase between a front axle and at least one rear axle, comprising a rear axle mount to mount the at least one rear axle at one or multiple locations on the frame.

19. The variable length agricultural trailer of claim 18, wherein the rear axle mounting system comprising present locations for mounting rear axle.

20. The variable length agricultural trailer of claim 18, wherein the flanges connecting the plurality of segments are angled to at least partially arch the segments relative to one another.
